(19) United States
(12) Patent Application Publication
(10) Pub. No.: US 2007/0130206 A1
(43) Pub. Date: Jun. 7, 2007

(54) System and Method For Integrating Heterogeneous Biomedical Information

(75) Inventors: Xiang Zhou, Exton, PA (US); Dorin Comaniciu, Princeton Junction, NJ (US); Alok Gupta, Bryn Mawr, PA (US); Zhuowen Tu, San Diego, CA (US); Daniel Fasulo, Titusville, NJ (US); Lu-yong Wang, New York, NY (US); Peiya Liu, East Brunswick, NJ (US); Saikat Mukherjee, North Brunswick, NJ (US); Amit Chakraborty, East Windsor, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH INC, Princeton, NJ (US)

(21) Appl. No.: 11/462,616

(22) Filed: Aug. 4, 2006

Related U.S. Application Data
(60) Provisional application No. 60/705,833, filed on Aug. 5, 2005.
(60) Provisional application No. 60/705,742, filed on Aug. 5, 2005.
(60) Provisional application No. 60/705,832, filed on Aug. 5, 2005.
(60) Provisional application No. 60/710,066, filed on Aug. 22, 2005.

(51) Int. Cl. G06F 17/00

(52) U.S. Cl. 707/104.1

(57) ABSTRACT

A system and method for using heterogeneous data from multiple healthcare information sources in a medical decision support system is disclosed. Each healthcare information system stores medical data using a different local schema. The medical decision support system provides responses to user queries. A query is received from a user that is generated in a standardized global schema. The query includes information from medical ontologies. Database queries are generated from the user queries that use the medical ontologies to generate constraints in the queries. The medical ontologies are also used to infer database queries. The generated query is translated into multiple queries for the multiple healthcare systems wherein each query is in the local schema of the healthcare information system that is being queried. Each database query is transmitted to one of the healthcare information systems based on the local schema of the particular query. Data is collected from each of the queried healthcare information system and analyzed. A query response is formulated for the user

### CROSS REFERENCE TO RELATED APPLICATIONS

This application claims the benefit of U.S. Provisional Application Ser. No. 60/705,833, filed Aug. 5, 2005, U.S. Provisional Application Ser. No. 60/705,832, filed Aug. 5, 2005, U.S. Provisional Application Ser. No. 60/705,742, filed Aug. 5, 2005 and U.S. Provisional Application Ser. No. 60/710,066, filed Aug. 22, 2005 which are incorporated by reference in their entirety.

### FIELD OF THE INVENTION

The present invention is directed to a system and method for integrating heterogeneous biomedical information, and more particularly, to a system and method for vertically integrating biomedical data that include genetic, clinical and epidemiological data.

### BACKGROUND OF THE INVENTION

Many techniques and tests are available to those in the medical community to assist in the diagnosis, monitoring and treatment of diseases. Among those commonly used include image processing tools such as X-ray, ultrasound, Magnetic Resonance imaging (MRI), and Computed Tomography (CT) systems. Clinical testing such as blood tests may also be used. Other techniques include the association of phenotype with genotype and epidemiology.

In medical image processing, registration has become a fundamental task that yields a mapping between the spatial positioning of two or more images and can be used in a variety of applications. The main requirement for the alignment transformation is to optimally overlay corresponding image content. The use of different imaging systems for the same subject can achieve more information but on the other hand requires multi-modality registration techniques for proper interpretation. The addition of complementary information is facilitated by various medical imaging systems that can be coarsely divided into two major categories: anatomical imaging to extract morphological information (e.g. X-Ray, Computed Tomography (CT), Magnetic Resonance Imaging (MRI), Ultrasound (US)), and functional imaging that visualizes information on the metabolism of the underlying anatomy (e.g. Single Photon Emission Computed Tomography (SPECT), Positron Emission Tomography (PET), functional MRI (fMRI)). In multi-modality image registration, the combination of different types of images is advantageous for the physician. For instance. CT images feature good spatial resolution, whereas PET images depict the functionality of the underlying tissue. The lack of functional information in the CT images can therefore be compensated by a fusion with corresponding PET images that on their part lack of spatial resolution.

In addition, the medical community has discovered that the field of genomics—the understanding of genetic material on a large scale—is playing an increasingly more important role in the diagnosis, monitoring and treatment of diseases. All diseases have a genetic component, whether inherited or resulting from the body's response to environmental stresses like viruses or toxins. Genomics allows physicians to pinpoint errors in the genes that cause or contribute to disease. It is hoped that this genetic information will ultimately lead to the development of treatments or cures for these diseases. Biotechnology companies are continually developing diagnostic tests to detect errant genes in people suspected of having particular diseases or being at risk for developing them. While some of these tests have already saved lives, interpretation of these tests is often difficult and unresolved among those in the medical community.

The information in a healthcare facility is present in different modalities across various repositories. The modalities range from unstructured text, in which physician reports are represented, to images from a host of medical examinations to structured databases containing billing, accounting, and personal information. As described above, there may also be genomics and proteomics (omics) data of the patients. The data represented in these different modalities are stored in different databases. For instance, medical images are stored in image databases while specialized databases host accounting and billing, information. Similarly, the plain text reports, from physician notes as well as laboratory testing, are stored in other databases. And the omics data require entirely different data storage systems and models. The heterogeneity of representation, in terms of the modality as well as the storage, gives rise to several critical problems for information access in a healthcare facility.

The problems get compounded when querying information systems of multiple healthcare facilities. Many of these facilities maintain data in their own native format and, consequently, it becomes almost impossible to relate information across them. As a result, if a patient has undergone tests and clinical procedures in multiple facilities, it becomes hard to gather data from these different sources and compose a holistic view of the patient. For instance, laboratories which specialize in genomic and proteomic testing could be different from laboratories specializing in image scans. The information of a patient going to both of these laboratories will be stored in their respective systems making it difficult for uniform query and access.

Decision support systems critically depend on rich information to make informed suggestions to the physician. When patient data is stored in heterogeneous formats in different systems, the performance of these decision support systems degrade since they have to cope with incomplete information due to the difficulty of querying the data sources.

In order to cope with this heterogeneity problem, data integration techniques have been proposed in the literature which reconciles the schemas of disparate sources. These techniques frequently rely on machine learning, linguistic heuristics, and domain knowledge to map elements between a pair of schemas. However, these techniques do not provide an end to end methodology for querying heterogeneous data sources. It would be advantageous to combine these different types of information into a single system. that is capable of integrating the information and using it to diagnose various diseases in patients.

### SUMMARY OF THE INVENTION

The present invention is directed to a system and method for using heterogeneous data from multiple healthcare information sources in a medical decision support system. Each healthcare information system stores medical data using a different local schema. The medical decision support system provides responses to user queries. A query is received from a user that is generated in a standardized global schema. The query includes information from medical ontologies. Database queries are generated from the user queries that use the medical ontologies to generate constraints in the queries. The medical ontologies are also used to infer database queries. The generated query is translated into multiple queries for the multiple healthcare systems wherein each query is in the local schema of the healthcare information system that is being queried. Each database query is transmitted to one of the healthcare information systems based on the local schema of the particular query. Data is collected from each of the queried healthcare information system and analyzed. A query response is formulated for the user.

### BRIEF DESCRIPTION OF THE DRAWINGS

Preferred embodiments of the present invention will be described below in more detail, wherein like reference numerals indicate like elements, with reference to the accompanying drawings:

FIG. 1 illustrates a block diagram of a system for implementing a method for accessing heterogeneous information using a declarative mapping representation for use in decision support systems in accordance with the present invention;

FIG. 2 is a flow chart that illustrates a method for constructing a query from a user's actions in accordance with the present invention;

FIG. 3 illustrates the overall flowchart for the query translation process in accordance with the present invention;

FIG. 4 illustrates an example of an integrated model of a heart in accordance with the present invention; and

FIG. 5 illustrates an integrated disease model for dilated cardiomyopathy in accordance with the present invention;

FIG. 6 is a logical diagram of components of an exemplary integrated healthcare system in accordance with the present invention;

### DETAILED DESCRIPTION

The present invention is directed to a system. and method for integrating heterogeneous biomedical information. The present invention provides seamless integration of traditional and emerging sources of biomedical information. A comprehensive view of a patient's health is obtained by vertically integrating biomedical data, information and knowledge that encompasses genetic, clinical and epidemiological information. The availability and integration of diverse medical datasets makes it possible for medical doctors and researchers to consider, pose, and efficiently evaluate new interesting hypotheses on how different attributes interact.

The system is dictated by three orthogonal views. First, relevant biomedical sources are modeled and integrated across different diseases or patient levels. Second, a grid-based service-oriented environment is developed to manage distributed and shared heterogeneous biomedical data and knowledge sources. Third, an integrated decision support and knowledge discovery system is used to provide assistance in disease prevention and patient care.

The biomedical data sources cover several vertical levels (from cellular information through organ information to patient and population information) and data and knowledge models are developed which integrate across the levels. Ontologies are used to formally express the medical domain, for improved communication of domain concepts among domain components, and to assist in the integration process. The ontologies provide semantic coherence of the integrated data model. Mapping discovery is used to identify similarities between ontologies, determining which concepts and properties represent similar notions either automatically or semi-automatically.

Once the data has been integrated, it can be used to create organ and disease models. In order to do this, aspects of the disease to be modeled must be defined as well as the data upon which those models depend. The disease models should also capture and represent evolution of proteins, cells, tissues, organs and their functions as a human body grows. The present invention is directed to an integrated healthcare platform for seamlessly and cohesively integrating traditional and emerging sources of biomedical information for each patient, providing integrated disease modeling, knowledge discovery and decision support systems.

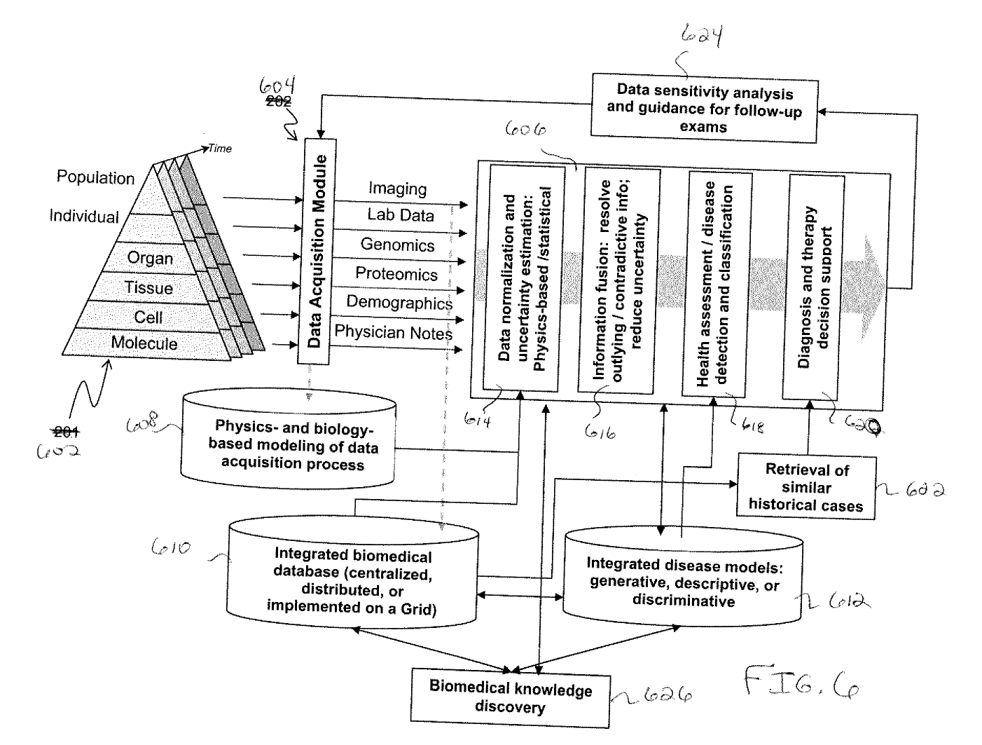

FIG. 6 is a logical diagram of components of an exemplary integrated healthcare system in accordance with the present invention. Component 602 illustrates the different types of data available for a patient population, for example a child population or a geriatric population. Component 602 captures multiple vertical levels of information from molecular, cell, tissue, to organ, individual, and population level. Component 604 represents the modules or processes for collection of biomedical data that is used by the integrated healthcare system. The present invention is an integrated approach for personalized healthcare over the full development period of a child from birth to adulthood. Multiple diseases are analyzed to gain general knowledge and broad experiences. Examples of disease categories which may be included are heart diseases, inflammatory diseases, and brain tumors. Component 606 represents the tools used by the integrated healthcare platform to provide biomedical or clinical decision support Component 606 interacts with databases 608-612.

Component 606 includes tools for integrated modeling of diseases. The aspects of the disease to be modeled and the data upon which those models depend are defined. Some models and tools which can be included in the integrated disease model include predictive models of disease outcome, identification of homogeneous subtypes, models of progressive organ damage, geometric modeling, integration of images across different imaging modalities, and quantification of subtle changes from registered images.

Component 606 also includes decision support systems and services for disease prevention, diagnosis, and treatment. Such systems and services will also support personalization of healthcare and lifestyle management. Many times decisions systems encounter missing data, measurement uncertainty, and outlying or inaccurate data. When uncertain data as pieces of information coming from multiple sources (clinical, imaging, genomic, and proteomics, etc.) are to be combined for a robust decision, information fusion algorithms play a central role. Data uncertainties, e.g., in terms of confidence intervals or covariances, can be estimated by Component 614 using either physics- or biology-based models (Component 608) of the object and the data acquisition module, or statistics extracted from categorized patients from the database (Component 610). A fusion estimator such as that disclosed in D. Comaniciu, Robust Information Fusion using Variable-Bandwidth Density Estimation, 6th ISIF/IEEE Int'I Conference on Information Fusion, Cairns, Australia, 2003, which is incorporated by reference can be used to combine the uncertain data, in a way such that outliers are discarded, contradictions are resolved, and uncertainty is reduced (Component 616),

Generative and discriminative models can also be used to support tasks such as disease and disease subclass classification, modeling, and prediction (Component 618). Techniques such as using probabilistic boosting trees as described in Z. Tu, “Probabilistic Boostino-Tree: Learning Discriminative Models for Classification, Clustering, and Detection”, Intl. Conf. On Computer Vision, Beijing, 2005, which is incorporated by reference can be used.

Retrieving similar cases from the past (either with expert diagnosis or known outcome) and comparing their biomedical data and diagnosis/outcome to the current patient is a very important aspect of the integrated healthcare system, and can help the diagnosis and therapy decision process (Component 620). During the retrieval of similar patient cases, user interaction can improve the retrieval performance. The allowable forms of user interaction will dictate the usability of the system. The use of statistical learning algorithms can shift the burden of feature space manipulation from the user to the machine, only requiring the user to provide feedback comments in the form of positive and negative examples. The system learns from these examples a perceptual similarity measure automatically. Small-sample learning algorithms based on Kernel BiasMap and Rankboosting can be a specific choice of such type of statistical learning algorithms.

Component 606 also includes tools for knowledge discovery. The availability and integration of diverse medical datasets makes it possible for medical doctors and researchers to consider, pose and efficiently evaluate new interesting hypotheses on how different attributes interact. Some knowledge discovery tools that can be used include refinement of disease models and associating phenotype with genotype. A fundamental data analysis and knowledge discovery question is how to properly combine different datasets, and consequently how to design similarity/distance metrics between objects (e.g. patients) that encode the information available in different datasets and explicitly incorporate user (e.g. medical doctor) feedback. Such distance metrics allow design of efficient clustering and classification techniques.

Component 624 provides recommendations regarding most informative additional exams for the patient in order to improve the confidence for diagnosis, therapy, or follow-up decisions. This component takes as input all current information for the patient, and one or more probabilistic diagnosis or therapy decisions, and output a recommendation of the next one or more most informative exams, for example, “please obtain family history”, or “please take a MRI scan of the disease region”, etc.

The integrated biomedical databases and the integrated healthcare system can be implemented on Grid, so that doctors from multiple hospitals can access the data and use the systems.

An example will now be described which exploits various aspects of the present invention. A child is born in a family in which there was an occurrence of idiopathic Dilated Cardiomyopathy (DCM). His biomedical record is progressively collected. Initial data (demographics, familial/pedigree, 2D/3D echocardiograms, blood tests—lactates, pyruvate, carnitrine, etc. and preliminary genetic analysis) are cohesively integrated into a healthcare database. All clinical specialists (pediatricians, cardiologists, radiologists and geneticists) at different sites have a shared and coherent view of the health of this child. During data integration, an integrated healthcare system applies robust information fusion to deal with uncertain, outlying and missing biomedical data.

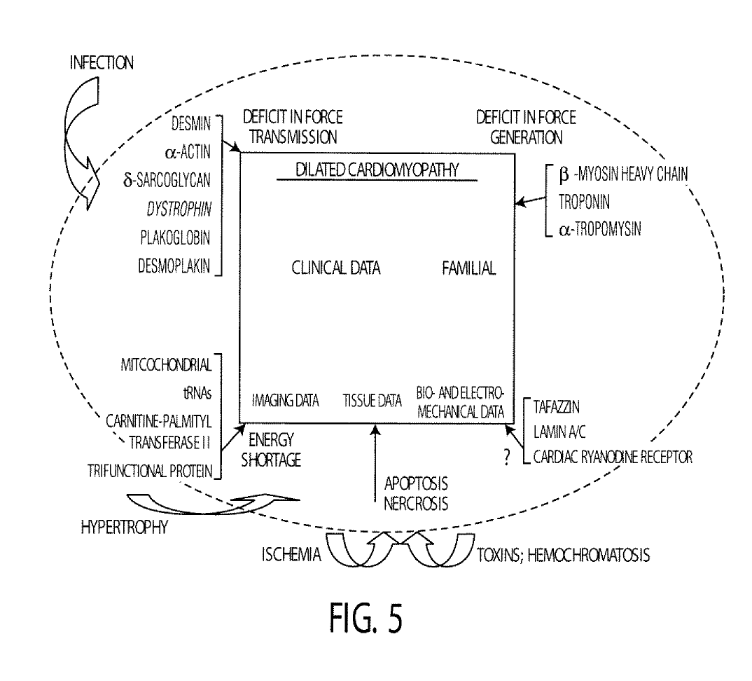

The integrated healthcare system comprises a generative model of DCM as shown in FIG. 5 that is constructed from. a collection of past DCM cases, each with biomedical information as inputs and with expert diagnosis or known outcome. It also contains a discriminative model learned from DCM patients against healthy controls. Advanced computer vision and pattern recognition tools localize, segment and characterize the heart chambers automatically from imaging data.

As indicated above, FIG. 5 illustrates an integrated disease model for dilated cardiomyopathy which includes clinical, electrocardiogram (ECG) imaging which can be done via different modalities (e.g., magnetic resonance imaging (MRI) or ultrasound), tissue biopsy and genetic factors which act jointly to contribute to a statistical, geometrical, bio- and electromechanical model of a diseased heart. The specific components of the integrated disease model shown in FIG. 5 are not particular to the present invention and other combinations of medical data or different types of medical data can be included or omitted without departing from the spirit of the present invention. As a generative model, the integrated disease model represents a wide variety of DCM sub-classes in the heterogeneous input space. It is understood by those skilled in the art that there are many different pathways that can lead to DCM. The integrated DCM model is built upon these complex associations which are continuously refined through time.

A data acquisition guidance system can be used to suggest more specific tests such as MRI catheterization and biopsy, further gene mutation and chromosomal analysis, SNP analysis and a personalized monitoring plan. Eventually during monitoring, imaging data start to show slight left ventricle (LV) enlargement. The doctor is alerted and turns to an intelligent retrieval system for searching and examining similar cases from distributed healthcare databases. The integrated healthcare system provides easy and intuitive interactions that can incorporate an expert's perceptual constraints of similarity (e.g., finding cases with a particular LV shape associated with a certain genotype). The diagnostic decision of DCM onset is thereby verified and further refined to a DCM subclass.

The integrated healthcare system also predicts disease progression for the coming years. A prevention/treatment plan especially fitted for his genomic or proteomic profile and existing symptoms is automatically suggested, such as preventative lifestyles or gene therapy. The likelihoods of a necessary transplant are also provided in time. Before the scheduled transplant, the medical system warns, based on patients with a similar profile, that this case has a high chance of rejection (due to e.g., cytokine, gene polymorphism). Therefore, the system suggests an early follow up and rejection prevention plan which is later adjusted by post-op biopsy and gene/protein expression profiling. It is to be understood by those skilled in the art that the integrated healthcare system is able to address multiple diseases in order to achieve general knowledge and experiences that can be generalized and not just DCM.

The integrated healthcare system enables tool sets focus on vertical aspects. Disease models are integrated, i.e., having multiple levels of biomedical information as inputs, including genetic information. Decision support systems utilize all biomedical information available for the patient. Knowledge discovery modules exploit whatever information is present across multiple heterogeneous databases, including not only traditional but also emerging sources of information, such as molecular or epidemiological data.

The integrated healthcare system provides seamless integration of traditional and emerging sources of biomedical information from molecule and cell level to individual and population level, across different hospitals and research institutions via multiple “virtual organizatons”. Integrated disease models are deployed across all available information levels, taking into account also temporal evolution. Large-scale, cross-modality, and longitudinal data mining and statistical learning algorithms and systems for medical knowledge discovery are deployed. Decision support systems and services are deployed that support novel clinical practice and personalized healthcare for children and, as the system grows with them, also adults.

One aspect of the present invention is the building of a comprehensive data, medical information and knowledge-discovery infrastructure for various higher-level components of the system. An important component is the modeling and integration of relevant biomedical data sources for improved medical knowledge-discovery and understanding. The physician is presented with a novel view of the medical domain via high level components whereby medical information spanning a range from genetics through individual to population is combined in a coherent picture. The biomedical data sources cover several vertical levels (from cellular information through organ information to patient and population information). Ontologies are also used to formally express the medical domain, for improved communication of domain concepts among domain components, and to assist in the integration process. Moreover, ontologies provide semantic coherence of the integrated data model, as ontological commitments are expected from the components. To exploit data and expertise distributed in multiple hospital and research institutions, grid-based biomedical databases are used.

Mapping discovery is used to identify similarities between ontologies, determine which concepts and properties represent similar notions automatically. Two major approaches exist for mapping discovery: top-down approach and heuristics approach. The top-down approach is applicable to ontologies with a well-defined goal. Ontologies usually contain a generally agreeable upper-level (top) ontology by developers of different applications. The upper-level ontologies can be extended with application specific terms. The heuristics approach uses lexical structural components of definitions to find correspondences with heuristics.

One embodiment of the present invention is directed to a method that relies on a language for declarative representation of the mappings between different schemas. Using this declarative representation, queries on the global schemas are translated to queries on the local schemas, answers computed and composed to generate the final results for the user. In addition, the present invention described a method for using medical ontologies for querying. The ontologies are used to generate the query on the global schema by: (a) choosing the appropriate global schema element, and (b) terminologies from them are used for specifying constraints in the query. Different aspects of the proposed method are described hereinafter.

In accordance with the present invention a grid-based service-oriented environment is used to manage distributed and shared heterogeneous biomedical data and knowledge sources, and to provide support for higher-level decision support components. Grid middleware provides a connectivity environment for managing diverse and dispersed resources; both data and compute resources. In the integrated healthcare system, the grid middleware hides the network topology of the participating hospitals, ensures secure access to sensitive data and virtualizes distributed data space.

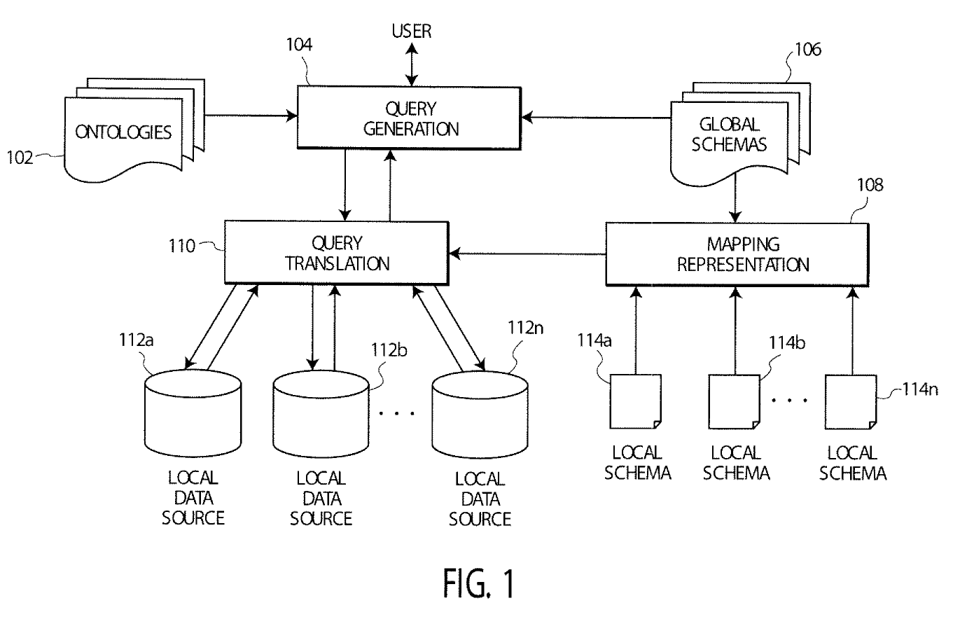

FIG. 1 illustrates a block diagram of a system for implementing a method for accessing heterogeneous information using a declarative mapping representation for use in decision support systems in accordance with the present invention. Data in individual healthcare facilities are stored and represented in local schemas 114a-114n and information systems. The localized schemas 114a-114n are mapped to global standardized schemas 106 using a mapping representation module 108. For instance, while a laboratory could represent clinical test results using its local schema, there would be a mapping from this local schema to the standard representation of test results.

The present invention is focused on the representation of the mapping such that heterogeneous data sources could be queried for information access. To this end, it is assumes that any of the different known techniques, using machine learning or linguistic knowledge or domain expertise or any combination of these, could be used to generate the mapping between a pair of schemas. Subsequently, the mapping is represented using our mapping specification language.

Another aspect of the present invention is medical query processing. The goal is to provide the necessary indexing, search and processing facilities, in the form of methods and metrics, for identifying information, knowledge and data fragments that are relevant to a particular request. This include metrics for comparison of vertically integrated biomedical objects and the use of indexing structures and techniques to assist in distributed data navigation. Optimization techniques are used to choose the best resources, the order of execution in order to improve speed of execution and responsiveness of the system.

A user generates a query using a global standardized schema 106. The Query Generator module 104 allows the user to browse the global schemas 106 and select, possibly multiple, elements from them as part of the query. The query generated by the user is enriched with information from medical ontologies 102. In the healthcare domain, rich sources of standardized information exist in ontologies and terminologies. For instance, LOINC (Logical Observation Identifiers Names and Codes) is a set of terminologies for the laboratory testing, ICD (International Classification of Diseases) is a hierarchical knowledge base of diseases, and UMLS (Unified Medical Language System) is an umbrella ontology of many different sub-ontologies in the medical domain. The Query Generator module 104 makes use of these ontologies and terminologies for providing constraints in the query as well inferring additional queries.

Global schemas are often mapped to domain ontologies. This would enable querying using the ontology directly rather than browsing the global schema. Specifically, the required global schema element is automatically selected once the user chooses the ontology concept and given the mapping between the concept and the schema element.

The Query Translator module 110 takes as input the query generated by the Query Generator module 104 and translates it into queries for the local data sources 112a-112n. The translation requires the mapping representation between the global and local schemas. Furthermore, this module 110 also collects the answers from the local data sources 112a-112n, composes the final results, and sends it back to the Query Generator module 104 which displays them to the user.

In order to translate queries from global to local schemas, it is necessary to know the mapping between the schema elements. We propose a declarative language for specifying this mapping. The rules in our language are as follows:
SchemaMap->Map*
Map->ElementGlobal Equivalent ElementLocal
ElementLocal->ElementLocal U ElementLocal
ElementLocal->ElementLocal∪ElementLocal
ElementLocal->SchemaElement
ElementGlobal->SchemaElement

The main features of the language will now be described. A rule SchemaMap describes the collection of all the mappings to the local schemas. A mapping between the global schemas and one local schema is described by a rule Map. A Map is represented as a triple consisting of an element from the global schema and element(s) from the local schema connected by an equivalent relation. The element from the global schema is always a single schema element and is represented by ElementGlobal in the language. In this respect, the mapping is always between a single global schema element and possibly multiple local schema elements. This representation is used to limit the complexity of the query translation process.

ElementLocal represents either a single element in the local schema, a union, or an intersection of such elements. The semantics of the union is that the global schema element can be considered to be equivalent to any of the local schema members in the union. The semantics of the intersection is that the global element is mapped to each and every one of the local schema members in the intersection. The global and local schema elements are related by equivalent relationship. The semantics of this relation is that the global element is equivalent to the local element(s). The semantics of these relationships as well as the union, intersection and the one-to-one mappings are used in the query translation process.

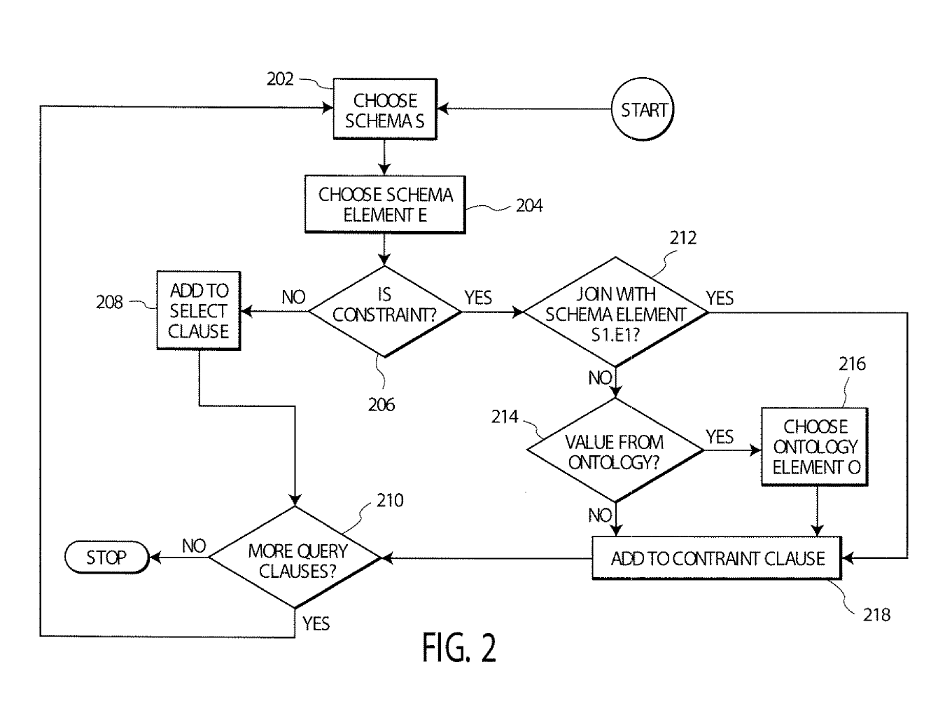

The task of the Query Generator module is to construct a query from. the user actions on the global schema and domain ontologies. FIG. 2 illustrates the processes involved in this module. The global schema is a collection of schemas some of which could be relational while others could be hierarchical. In order to capture the expressiveness of queries over these different schemas we model the query into two parts: (a) a “select” clause, and (b) a “constraint” clause. The “select” clause represents schema elements whose values are requested as output. The “constraint” clause represents schema elements used for constraining the selection.

The user first selects a schema S from the set of global schemas (step 202). An element E from this schema is then subsequently chosen (step 204). If the chosen element is not a part of the constraint clause (step 206), then it is added to the select clause (step 208).

If the chosen element is part of the constraint clause (step 206), then the element is being used for data filtering. The filtering is done based on its value which can be assigned in one of three ways. In the first case, the element's value has to be equal to another schema element's value (join) (step 212). An expression of the form S.E op SLEI is added to the constraint clause (step 218). In the second case, the element's value is selected from a domain ontology (step 214). This is very useful in the medical domain since the existing rich ontologies can be leveraged for standardizing queries. In this case, an expression of the S.E op O.V where O is the selected ontology (e.g. ICD) and V is an element from it is added to the constraint clause (step 218). If neither of these cases exist, the user enters a value for the schema element (step 216). An expression of the form S.E op V, where V is the value entered, is added to the constraint clause (step 218). In the above three cases, op could be any of the standard arithmetic operators used in database query languages such as SQL (Structured Query Language). For instance, op could be =, <, >, >=, <=, in, etc.

The process of adding the new clause to the constraint base serves a number of purposes. If the new clause is a conjunction (AND) to an existing clause, then it is added to it as a conjunct. If the new clause is a disjunction (OR) to an existing clause, then it added to it as a disjunct. If neither of the above then it exists as an independent constraint. The process starting from schema selection to rule creation is repeated until there are no more clauses to be added to the query.

The ontology can not only be used for providing values for posing constraints to the query but also for automatic query construction. Often, mappings exist between the global schemas and domain ontologies. In the extreme case, an ontology is directly used as the global schema model. When these mappings exist, it is not necessary for the user to browse the global data model to construct the query. The user can select the appropriate the ontology concept and the query is generated automatically using the mapping. The process for constructing this query is exactly identical to the manner in which queries on the global schemas are translated into queries on the local schemas. This is explained in more detail in Query Translation.

Query translation is the process of rewriting the query on the global schemas to every individual local schema set. This process is carried out using the mapping between the global schema elements in the query to their local schema counterparts. We use XPath as the language for querying hierarchical local schemas and SQL as the language for querying relational schemas.

Depending on the nature of the query generated and the mapping between the global and local schemas, translation involves the following scenarios. In the following, these scenarios are outlined where the global schema element in the query is denoted by GElem and the local schema element is denoted by LElem. For each of these scenarios, the query expressions created are also described. The part (a) describes the expression if the element is part of the select clause while (b) describes the expression for constraint clause.
1. GElem is a leaf node in a hierarchical schema and LElem is a leaf node in a hierarchical schema.
   a. An XPath expression corresponding to the path from the root of the local schema to LElem is generated e.g. /a/b/LElem, where a and b are schema elements denoting the path from the root to LElem in the local schema.
   b. An XPath expression corresponding to the path from the root of the local schema to LElem. is generated along with the value check at the leaf e.g. /a/b/[c=‘v’] where v is the constraint value.
2. GElem is a leaf node in a hierarchical schema and LElem is a internal node in a hierarchical schema.
   a. Same as 1.a.
   b. For constraints, the specified value could be present in any leaf node in the subtree rooted at LElem. Thus, the corresponding XPath could he, for instance, /a/b/LElem//[*=‘v’] which indicates a match of v against any node in the subtree rooted at LElem.
3. GELlem is a leaf node in a hierarchical schema and LElem is a single relational schema element.
   a. A SQL query is generated with only the SELECT fragment specifying LElem.
   b. A SQL query is generated with only the WHERE fragment and the constraint LElem=‘v’.
4. GElem is an internal node in a hierarchical schema and LElem is a single leaf node in a hierarchical schema.
   a. Same as 1.a.
   b. Same as 1.b.
5. GElem is an internal node in a hierarchical schema and LElem is a single internal node in a hierarchical schema.
   a. Same as 1.a.
   b. Same as 2.b.
6. GElem is an internal node in a hierarchical schema and LElem is a single relational schema element.
   a. Same as 3.a.
   b. Same as 3.h.
7. GElem is a relational schema element and LElem is a single leaf node in a hierarchical schema.
   a. Same as 1.a.
   b. Same as 1.b.
8. GElem is a relational schema element and LElem is a single internal node in a hierarchical schema.
   a. Same as 1.a.
   b. Same as 2.b.
9. GElem is a relational schema element and LElem is a single relational schema element.
   a. Same as 3.a.
   b. Same as 3.b.

In the above the value v could be another schema element (path expression for hierarchical schema) in which case it would be a join. The above cases denote the different mappings situations between a single global and a single local schema element. Recall that our mapping representation language has also the capability to express union and intersection of local schema elements and a global element. We describe now the query rewriting under these cases in a recursive way.

For the union operation two different queries are created; one for each operand of the union. For instance, if GElem=LElem ULElem′, where LElem′ could be a compound of other singleton local schema elements connected by union or intersection, then a query for the map from GElem to LElem is created. Next, a set of queries for the map from GElem to LElem′ is created. If the mapping was part of a select clause, then GElem and LElem remain as separate queries with the rewriting of constraints attached to both of them. After the queries are executed, if there is a non-empty result from any of them, then all the results are returned as answers. If the mapping was part of a constraint clause, then the queries added as disjunctions either to the XPath expression or to the SQL WHERE query.

For an intersection operation, e.g. GElem=LElem∩LElem′, a query for the map from GElem to LElem is created. Next, a set of queries for the map from GElem to LElem′ is created. If the mapping was part of a select clause, then they remain as separate queries with the rewriting of constrains attached to both of them. After the queries are executed, only if there is a non-empty result from all of them then the intersecting results i.e. the results common to both of them are returned as answers. If the mapping was part of a constraint clause, then the queries added as con junctions either to the XPath expression or to the SQL WHERE query.

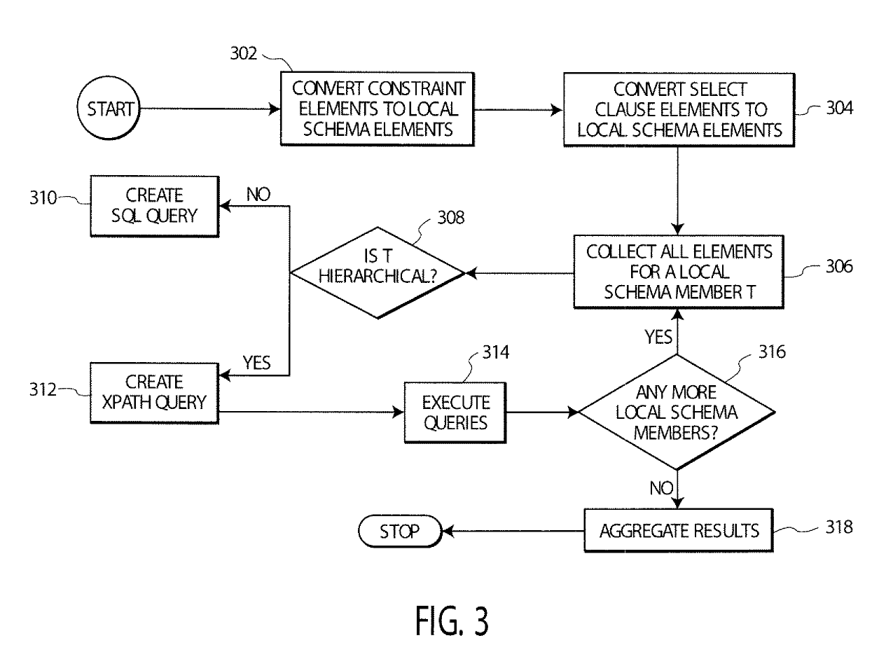

FIG. 3 illustrates the overall flowchart for the query translation process in accordance with the present invention. The global schema elements specified in the constraint clauses of the original query are converted to their local elements using the mapping representation (step 302). This is done using the steps described above. Similarly, the global schema elements in the select clauses are also converted to the local schema elements (step 304). This is also done using the steps described above. For each local schema element member, i.e. an individual relational or hierarchical schema, all its elements being used in the query are collected (step 306).

If the member is hierarchical (step 308), then an XPath query is created from the elements used (step 312). The query is created in three parts: (a) the XPath corresponding to all the constraints are created, (b) the XPath for the selection is created, and (c) these two XPath queries are merged to form a single XPath. For instance, if the constraint XPath is /a/b[c=‘v’] and the selection XPath is /a/b/d then the merged XPath is /a/b[c=‘v’]/d. If the member is relational, then a SQL query is created (step 310). The constraints are used in the where clause of the query while the selection elements are used in the select clause and the member name makes up the clause. These queries, one for every local schema element member, are executed on their respective databases and results aggregated and returned to the query generator layer (steps 314-318). While returning the final results, the intersection and union of select clauses of queries are checked and appropriate actions, as described above in this section, are taken.

The availability and integration of diverse medical datasets makes it possible for medical doctors and researchers to consider, pose, and efficiently evaluate how different attributes interact. Some examples of how the present invention can be used will now be described. A supervised learning approach can he used to make associations between patient data and outcome. For example, a determination can be made as to whether a patient remained free of a disease for five years after surgical removal of a tumor without additional treatment. A model is constructed to classify new patients based on their data and can output a list of data elements that are most significant in the classification.

In another instance, a clinician may notice a particular feature in imaging data which is present in some patients but not others. For example, a tumor surface may be smooth and isolated from the surrounding tissue, or may be irregular and fused into the surrounding tissue. The system can be queried to find out if there is other patient data, for example patterns of genomic markers that correlate well with the observation. Clustering analysis or expert knowledge from outside sources may suggest that patient be partitioned into different groups based on different patterns of genetic markers. A query can then be made to determine whether these subgroups correlate well with any other feature of the disease such as tumor appearance, success of different treatment strategies and overall outcome.

A clinician can also use the present invention to make associations between patient data and outcome. For example, a determination can be made as to whether a patient avoided the need for a transplant after a specific type of gene therapy was applied. A model is constructed to classify new patients based on their data, as well as output a list of data elements that are most significant in the classification. Alternatively, a determination could be made as to whether a preventative lifestyle that is prescribed by patients improves their condition and avoids the need for a transplant, or delays it for a number of years. The system derives associations in the form of fuzzy rules indicating the most significant lifestyle changes that affect outcome while being able to predict disease progression for new patients.

Another example of how the present invention may be used is in the case of Juvenile Idiopathic Arthritis (JIA). An investigation can be done to look for a possible correlation between the rate of occurrence of the disease, or its course, severity and time to progression, and specific demographic data (e.g., geographic region), leading to further study that could explain the differences (e.g., could the regional diet, climate, or pollution level affect the disease occurrence and progression). Another approach might perform a correlation analysis of JIA subtypes and genotypes of OPN (SNP and haplotypes).

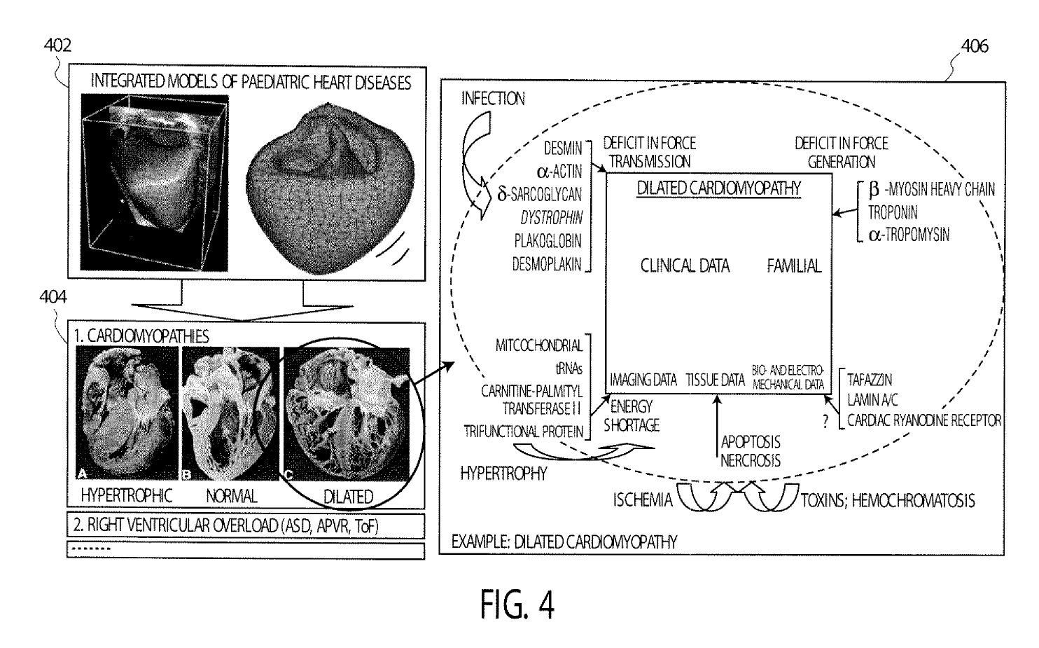

Another example of how the present invention can be used is to create an integrated model of a diseased heart. Deformable heart models can be built that can be adapted to specific diseases under consideration, for example, right ventricular overload and dilated and hypertropic cardiomyopathies. The anatomy of each model can be manually modeled or can be learned from available data and images. A-posteriori studies are run to learn the relationship between the model parameters and additional information from molecular/genetic data and tissue biopsy. With different inputs (e.g., genotypic information, or imaging cues of ASD), the model deforms to represent different diseases. FIG. 4 illustrates an example of an integrated model of a heart in accordance with the present invention.

The integrated model shows a geometric model of the heart 402 with electromechanical interactions with 3D+time cardiac images. As described above, with different inputs (e.g., genotypic information or imaging cues of ASD), the model deforms and evolves to represent different diseases in time. Box 404 shows different diseases that can he represented by the model. Box 406 illustrates a graphical representation of dilated cardiomyopathy in a unified view, underling different genetic factors and pathways that can lead to dilated cardiomyopathy.

Having described embodiments for a method for integrating heterogeneous biomedical information, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

We claim:

1. A method for using heterogeneous data from multiple healthcare information systems in a medical decision support system, each healthcare information system storing medical data using a different local schema, the medical decision support system providing, responses to user queries, the method comprising the steps of:
receiving a query from a user generated in a standardized global schema, the query including information from medical ontologies;
generating database queries from the user query, the generated queries using the medical ontologies to generate constraints in the queries, the medical ontologies also used to infer database queries;
translating the generated query into multiple queries for the multiple healthcare systems wherein each query is in the local schema of the healthcare information system that is being queried;
transmitting each database query to one of the healthcare information system based on the local schema of the particular query;
collecting data from each of the queried healthcare information system;
analyzing the collected data; and
formulating, a query response for the user.

2. The method of claim 1 wherein the step of generating a database query further comprises the steps of:
using the medical ontologies from the user query to generate a query that includes select clauses and constraint clauses such that the select clauses represent schema elements whose values are requested as output and constraint clauses represent schema elements used for constraining the selection; and
continuing to add constraint clauses and select clauses until there are no more clauses to be added to the query.

3. The method of claim 1 wherein the step of translating the generated query into multiple queries further comprises the steps of:
determining for each database query which healthcare information system to be queried;
mapping the global schema of each database query into a local schema consistent with the healthcare information system to be queried.

4. The method of claim 3 wherein the step of mapping to the global schema to a local schema further comprises the step of:
mapping the database query to a rule map which describe all mappings between the global schema and each local schema, each rule map being represented as an element from the global schema and an element from the local schema that are connected by a relation.

5. The method of claim 1 wherein the global schema is a relational data model.

6. The method of claim 1 wherein the global schema is a hierarchical data model.

7. The method of claim 1 wherein the step of analyzing the collected data further comprises:
aggregating the results received from every healthcare information system that is sent a database query.

8. The method of claim 3 wherein the step of mapping the global schema of each database query into a local schema further comprises using intersection and union operators.

9. The method of claim 1 wherein the local schema is a relational data model.

10. The method of claim 1 wherein the local schema is a relational data model.

11. The method of claim 1 wherein a generated query is expressed as a combination of hierarchical and relational data models.

12. A medical decisions support system for analyzing medical data received from multiple healthcare information systems in response to a user query, each healthcare information system using a different local schema and including at least one database that comprises medical data, the system comprising:
means for mapping local schema associated with each healthcare information systems with a global standardized schema;
means for generating a set of database queries based on a user query, the user query including medical ontologies that are used in the generation of the database queries;
means for translating the database queries into queries for the different healthcare information systems, each query translated into the local schema associated with the particular healthcare information system for which the query is to be directed;
means for receiving the responses to the translated database queries and analyzing the responses, the analyzed responses being generated into results that are communicated to the user;
means for displaying the results.

13. The system according to claim 12 generating means uses the medical ontologies from the user query to generate a queries that includes select clauses and constraint clauses such that the select clauses represent schema elements whose values are requested as output and constraint clauses represent schema elements used for constraining the selection.

14. The system of claim 12 wherein the translating means determines for each database query which healthcare information system to be queried and maps the global schema of each database query into a local schema consistent with the healthcare information system to be queried.

15. The system of claim 14 wherein the translation means maps the database query to a rule map which describe all mappings between the global schema and each local schema, each rule map being represented as an element from the global schema and an element from the local schema that are connected by a relation.

16. The system of claim 12 wherein the global schema is a relational data model.

17. The system of claim 12 wherein the global schema is a hierarchical data model.

18. The system of claim 12 wherein the receiving means aggregates the results received from every healthcare information system that is sent a database query.

19. The system of claim 14 wherein the translation means uses intersection and union operators to map the global schema of each database query into a local schema.

20. The system of claim 12 wherein the local schema is a relational data model

21. The system of claim 12 wherein the local schema is a relational data model.

22. The system of claim 12 wherein a generated query is expressed as a combination of hierarchical and relational data models.
